(19) United States
(12) Patent Application Publication
(10) Pub. No.: US 2017/0341319 A1
(43) Pub. Date: Nov. 30, 2017

(54) METHOD OF MOULDING

(71) Applicant: Alan Harper Composites Limited, Saltash (GB)

(72) Inventor: Alan Roger Harper, Cornwall (GB)

(21) Appl. No.: 15/609,491

(22) Filed: May 31, 2017

(30) Foreign Application Priority Data
May 31, 2016 (GB) 1609476.5
Sep. 19, 2016 (GB) 1615871.9

(51) Int. Cl. B29C 70/54; B29C 70/44

(52) U.S. Cl. CPC B29C 70/548; B29C 70/44

(57) ABSTRACT

A method of moulding includes placing reinforcing fibre between a mould surface and a flexible diaphragm, and causing upward movement of the diaphragm to produce a resin flow channel along which resin is caused to flow.

### CROSS REFERENCE TO RELATED APPLICATIONS

This application claims priority under 35 USC §119 to British Patent Application No. 1609476.5 filed on May 31, 2016 and British Patent Application No. 1615871.9 filed on Sep. 19, 2016. Both applications are hereby incorporated by reference in their entirety.

### TECHNICAL FIELD

This invention relates to a method of moulding with liquid resin.

It is an object of the present invention to provide an improved method of moulding with liquid resin, particularly one which includes assisting resin infusion/injection into reinforcing fibre or other less permeable material.

### SUMMARY OF THE INVENTION

According to the present invention there is provided a method of moulding which includes placing reinforcing fibre between a mould surface and a flexible diaphragm, and causing upward movement of the diaphragm to produce a resin flow channel along which resin is caused to flow.

A reusable element formed with a plurality of resin flow channels may be positioned beneath the flexible diaphragm.

The reusable element may be in the form of a disc with the resin flow channels formed in the upper surface thereof. The periphery of the disc may be chamfered.

A spigot and socket arrangement may be employed for holding the disc in the required position.

### BRIEF DESCRIPTION OF THE DRAWINGS

FIG. 1A is a schematic sectional view of the moulding system prior to the commencement of a moulding operation,

FIG. 1B shows the connection of a pipe to the chamber of the moulding system,

FIG. 1C shows a stage in the moulding operation,

FIG. 2 is a plan view of a reusable rubber disc,

FIG. 3 is a sectional view of the rubber disc along the line A-A of FIG. 2, and

FIG. 4 is a sectional view showing the rubber disc in position during a moulding operation.

### DESCRIPTION OF THE PREFERRED EMBODIMENTS

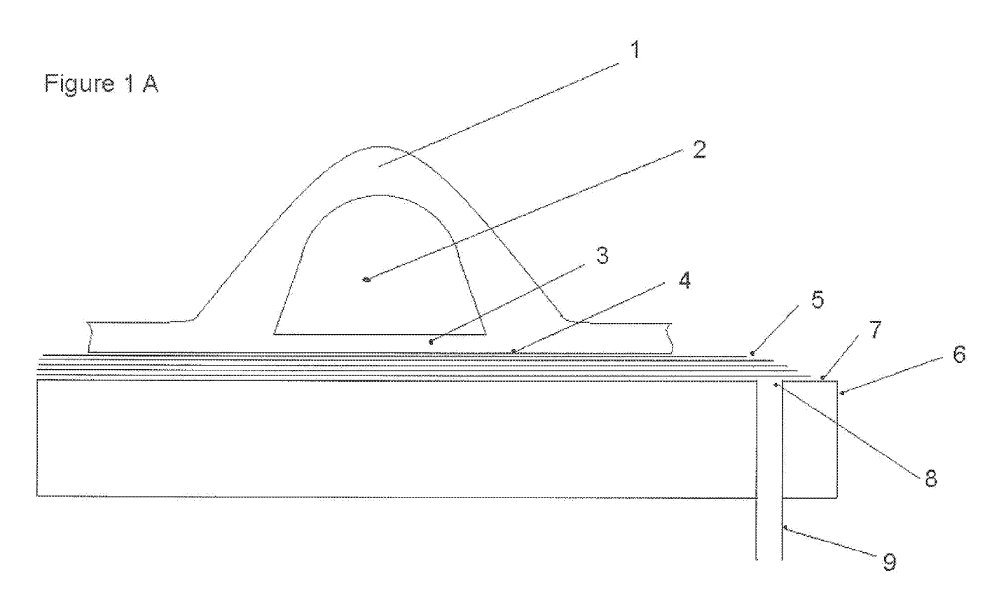

FIG. 1A shows a flexible, reusable morph resin runner 1 placed on top of a mould 6 having an upwardly presented moulding surface 7. The runner 1 includes a chamber 2 the lower boundary wall of which is afforded by a chamber diaphragm 3 having a downwardly presented resin moulding (or morph) surface 4. The resin runner 1 is manufactured in suitable lengths and is placed on top of a stack of fibre reinforcement layers 5 sitting on the moulding surface 7.

The arrangement shown in the drawings is extended and sealed at both ends so that a vacuum may be applied and maintained in the fibre layers 5 between the moulding surface and the morph surface 4. The connection to the vacuum pump (not shown) is via a vertical duct 9 the upper end of which is at point 8 of the face mould 6.

FIG. 1B shows a vertically extending pipe 10 connected to the chamber 2 and, once a vacuum has been applied to the fibre reinforcement layers via pipe 9, a vacuum is applied to the morph chamber 2 via the pipe 10. As the pressure applied to the upper surface of the chamber diaphragm 3 is the pressure applied to the lower surface of the chamber diaphragm 3, the diaphragm 3 will remain flat, as shown in FIG. 1B, resting on top of the fibre layers 5.

FIG. 1C shows a resin supply pipe 11 positioned in close proximity to the diaphragm 3. The lower end 12 of the inlet pipe 11 is so shaped at 13 as to permit the flow of resin down the inlet pipe 11 over the fibre layers 5 into the space beneath the morph diaphragm 3. At this crucial stage in the procedure, the pressure P2 of the incoming resin is substantially greater than the vacuum pressure P1 in pipes 10 and 11. As a result, the pressure of the incoming resin exerts a force upon the close surroundings. This force results in upward deflection of the diaphragm 3 into the free space within the chamber 2 so that the diaphragm 3 has the configuration shown in FIG. 1A.This results in the formation of a passage or channel 14 beneath the diaphragm 3 and above the fibre layers 5. This channel 14 will extend for the length of the morph.

Thus, as resin continues to flow down the supply pipe 11 under the pressure P2, the channel 14 will remain open as the pressure within the channel 14 remains substantially uniform, being spread by the hydraulic nature of the resin. It is to be appreciated that the fibre layers 5 present a much reduced flow passage to the resin feed. This, therefore, allows the inlet pressure P2 to back up and continue to force the most remote ends of the diaphragm 3 upwardly. Thus, the pressure P2 of the incoming resin actually opens up the channel 14 at a progressive rate depending on the permeability of the fibre layers 5, the resin viscosity and the pressure difference, i.e. P2-P1.

Once the mould has been filled to the required extent, the supply of resin to the inlet pipe 11 is stopped and the vacuum connection to pipe 10 is removed. P1 returns to atmospheric pressure and, as a result, the flexible diaphragm 3 is no longer being pushed upwardly and gradually returns to its formed flat position, as shown in FIG. 1B. This takes time, i.e. the time taken to push the necessary volume of resin out of the channel 14. The time taken to do this can be reduced using controlled increased external pressure applied to the inlet pipe 10. Once the passage or channel 14 has been emptied, the external pressure can be removed leaving pipe 10 open to atmospheric pressure.

As described above, resin is caused to flow over and into dry reinforced fibre layers without producing any post-moulding witness of the resin transport lines or potential resin-rich cure exothermic distortions.

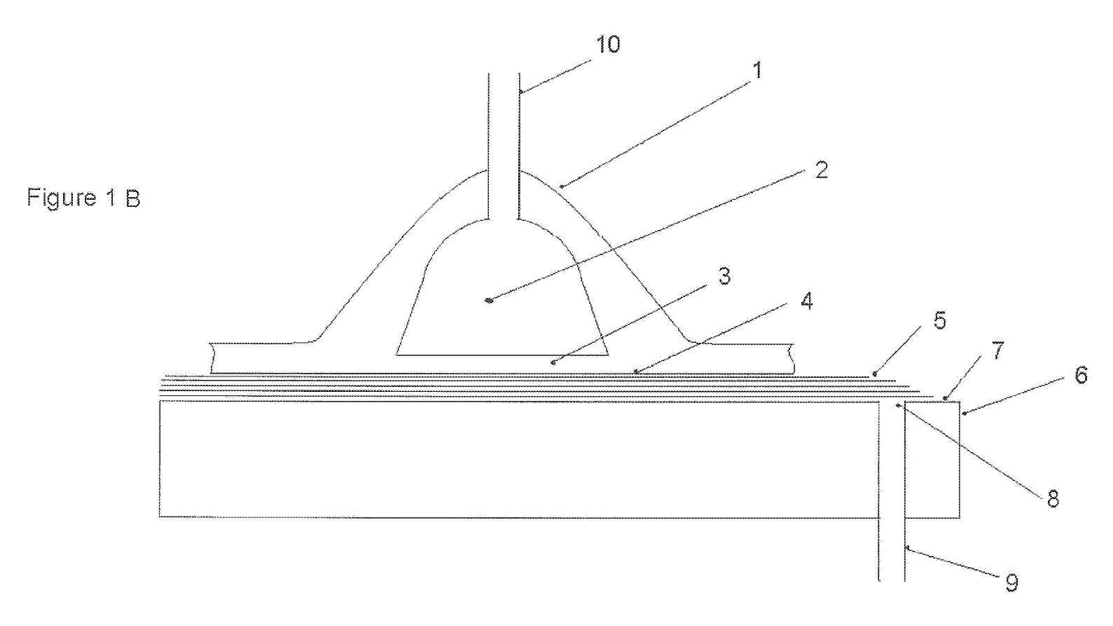

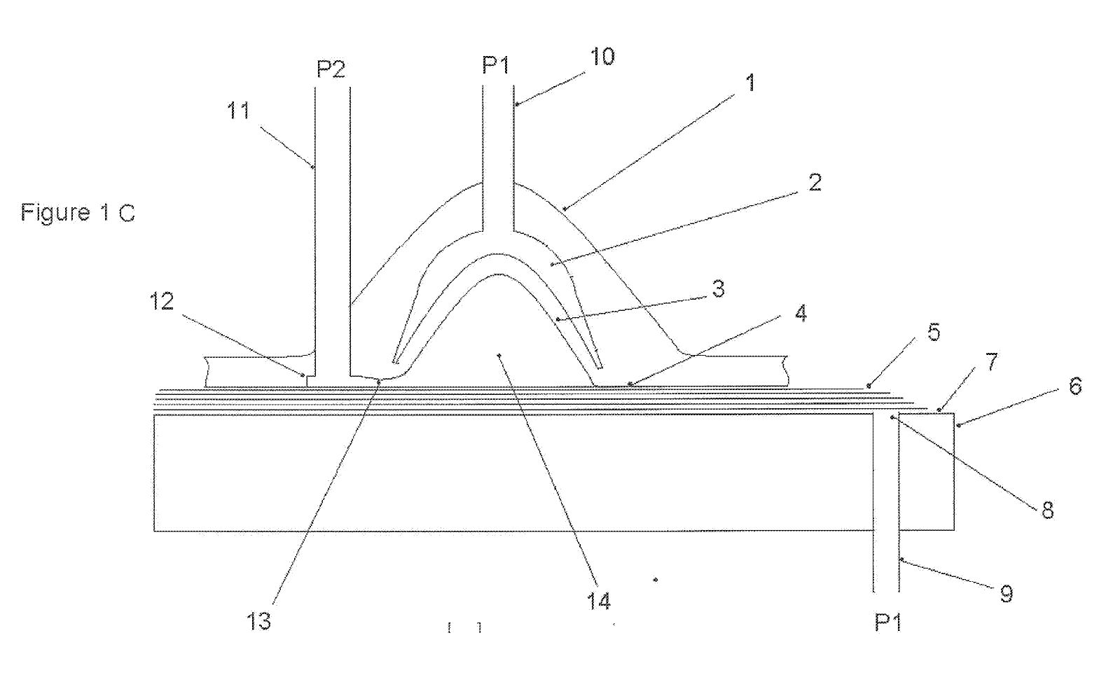

FIGS. 2 and 3 show a reusable rubber disc 20 which, during a moulding operation, is placed on top of fibre mats 21 which, in turn, sit on top of a mould 22. The disc 20 has an upper surface 23 and a lower surface 24. The edge of the disc 20 is chamfered or inclined, as indicated at 25, so that there is a variation in thickness of full thickness to zero thickness. The disc 20 has a flat, full thickness central portion 26 in which is formed an almost circular recess and five equi-angularly spaced elongated recesses 27 that extend from one side of the recess within which there is a point indicated as 28 in FIG. 2. The recesses 27 have a substantially uniform depth as indicated at 29 in FIG. 3.

The rubber disc 20 is placed beneath a reusable vacuum membrane 30 with the resin entry point in direct alignment with point 28 and with the elongated recesses 27 coinciding with and crossing the membrane “Morphflo” channel as explained above with reference to FIGS. 1A, 1B and 1C.

The reusable vacuum membrane 30 is always produced with an adjacent resin inlet insert located as close as possible to the moulded “Morphflo” channels so that the channels 27 in the rubber disc 20 direct the incoming resin under the reusable membrane 30 and over the fibre mats 21. The dimensions of the channels 27 and the number thereof are such that there is substantially no resin flow restriction. The reusable membrane 30 has a surface 31 which, under the vacuum conditions within the fibre mats 21 sitting on top of the mould 22, is distorted to form a negative shape, as indicated at 32, over the disc 20. During a moulding operation, i.e. during the flow of resin under pressure, the surfaces 24 and 31 are maintained level and a level moulding surface is thus produced. There is thus no witness of resin entry in the cured resin moulding.

The rubber disc 20 formed with recesses may be referred to as a “Crowsfoot” disc and its peripheral configuration and thickness may be varied from that shown in the drawings. Positioning sockets may be built into the membrane 30 to hold the “Crowsfoot” disc 20 in the required position.

It is also possible to use a “Crowsfoot” disc 20 in a moulding operation in which the reusable membrane 30 is replaced by conventional consumable bag material.

A modification to the above design of “Crowsfoot” disc enables this general procedure to be used as a horizontal cross-over flow channel between two separate “MorphFlo” channels, thus providing unlimited multi-“MorphFlo” stand-alone sealed channels that permit resin cross-over from one to the other.

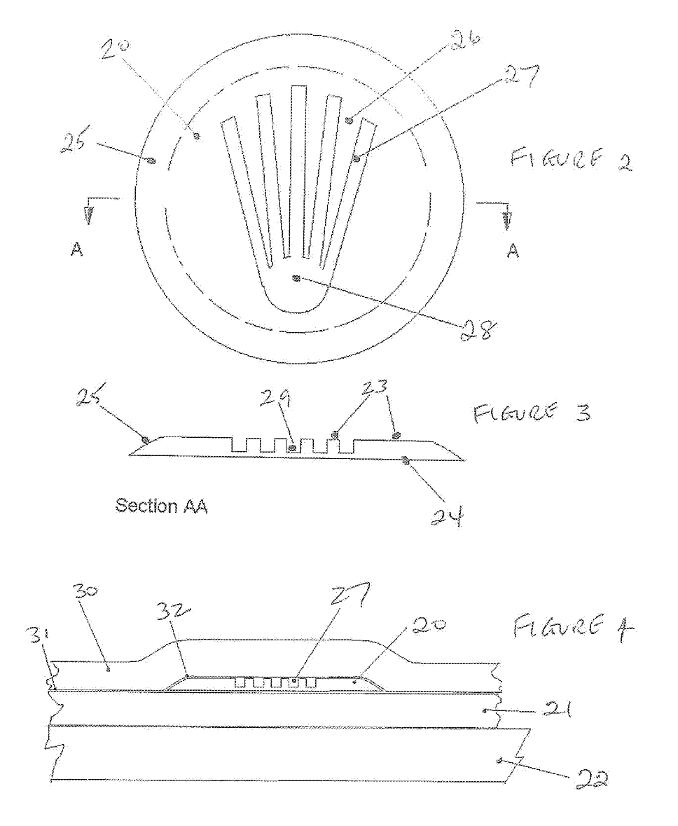

In the arrangement shown in FIGS. 2 to 4, the disc 20 is placed upon the fibre mats 21 and allows the resin to enter a standard hole fitting in the membrane 30 and to be diverted at 90 degrees across the fibre pack and reach the morph section which has a vacuum equal to that of the fibre pack. As the pressure of the resin is at or close to atmospheric pressure, this forces the morph flow section upwards to open the morph flow channel above the fibre pack.

This allows the resin to enter the mould cavity along predefined routes and, when injection of the resin is complete, the morph is made to flatten to the fibre pack thus eliminating any post-cure resin flow marks. The “Crowsfoot” cross-flow remaining cured resin is isolated from the infused and cured fibre pack thus ensuring that no cured resin remains upon the face of the moulded component.

What is claimed is:

1. A method of moulding which includes placing reinforcing fibre between a mould surface and a flexible diaphragm, and causing upward movement of the diaphragm to produce a resin flow channel along which resin is caused to flow.

2. The method of moulding as claimed in claim 1, in which a reusable element formed with a plurality of resin flow channels is positioned beneath the flexible diaphragm.

3. The method of moulding as claimed in claim 2, in which the reusable element is in the form of a disc with the resin flow channels formed in the upper surface thereof.

4. The method of moulding as claimed in claim 2, in which the periphery of the disc is chamfered.

5. The method of moulding as claimed in claim 1, in which a reusable element is positioned between the mould surface and a plurality of flexible diaphragms.
